(19) United States
(12) Patent Application Publication
(10) Pub. No.: US 2025/0297754 A1
(43) Pub. Date: Sep. 25, 2025

(54) DEVICE HAVING A HEAT EXCHANGER AND METHOD FOR OPERATING A HEAT EXCHANGER OF A DEVICE

(71) Applicant: GÜNTNER GMBH & CO. KG, Fürstenfeldbruck (DE)

(72) Inventors: Jörg KÖCHER, Utting (DE); Michael FREIHERR, Gröbenzell (DE)

(21) Appl. No.: 18/861,061

(22) PCT Filed: May 25, 2023
(86) PCT No.: PCT/EP2023/064090

§ 371 Date: Oct. 28, 2024

(30) Foreign Application Priority Data
May 27, 2022 (DE) 10 2022 113 409.1

(51) Int. Cl. F24F 11/41; F25B 47/02; F25B 49/02; F28F 17/00

(52) U.S. Cl. CPC F24F 11/41; F25B 47/022; F25B 49/02; F28F 17/00; F25B 2347/02

(57) ABSTRACT

A device having a heat exchanger, wherein the heat exchanger has pipes which carry a cooling medium, wherein the heat exchanger has a fin arrangement which is penetrated by the pipes, and wherein the heat exchanger has a heating device integrated in the heat exchanger, with a control device for controlling the heating device, wherein the heating device has two or more separately controllable heating sections, wherein each heating section is assigned a defrosting area of the heat exchanger, and wherein the heating device is set up for the separate defrosting of individual defrosting areas of the heat exchanger by the separately controllable heating sections.

### CROSS-REFERENCE TO RELATED APPLICATIONS

This application is a 35 U.S.C. § 371 National Stage patent application of PCT/EP2023/064090, filed on 25 May 2023, which claims the benefit of German patent application 10 2022 113 409.1, filed on 27 May 2022, the disclosures of which are incorporated herein by reference in their entirety.

### TECHNICAL FIELD

The present disclosure relates to a device with a heat exchanger and a method for operating a heat exchanger of a device.

### BACKGROUND

Heat exchangers are used to remove heat from a system to be cooled or to introduce heat into a system to be heated. In the field of refrigeration technology, heat exchangers are used to remove heat from a volume to be cooled by transferring a cooling medium from the liquid to the gaseous phase, wherein the heat exchanger is used as an evaporator. Similarly, a heat exchanger can be used in the field of heating technology to absorb ambient heat from the outside air in order to provide heat for a building to be heated in conjunction with a heat pump. Conversely, such a heat exchanger can also be used as a condenser or recooler to release heat into the environment.

Regardless of the particular application, it is crucial for the reliable and fault-free functioning of the heat exchanger that heat transfer between the heat exchanger and its surroundings is not restricted by interfering influences that isolate the heat exchanger from its surroundings. Such interfering influences are, for example, soiling or icing of the heat exchanger, which can accumulate between the fins or fin packs of the heat exchanger,

Heat exchangers often have fins or fin packs in order to provide the largest possible surface area available for heat transfer while keeping the size small. In the practical operation of such a heat exchanger, moisture from the surroundings of the fins may condense on their surfaces, causing these surfaces and the spaces between the fins to ice up. Due to the insulating effect of this icing, the heat transfer between the environment of the heat exchanger and its fins or the corresponding fluid conducted within the heat exchanger is impaired. In addition, the air flow through the heat exchanger is impaired, increasing the pressure loss and reducing the performance as less air flows through the heat exchanger. In this state, the heat exchanger may no longer provide the required cooling capacity or heat output. This can lead to the destruction of the cooled goods or to the failure of a system to be cooled. Furthermore, icing can damage the components of the heat exchanger.

In order to remove the icing, it is known to defrost the heat exchanger using a heating device. Such defrosting should be carried out as efficiently as possible. If defrosting is carried out too frequently or over too long a period of time, an unnecessarily large amount of heating energy is introduced into a volume that is to be cooled, for example, which then has to be removed with the aid of the heat exchanger in order to maintain or set the intended cooling temperature. If defrosting is carried out too Infrequently or for too short a period, defrosting is not effective and the functionality of the system in question is impaired. Well-known methods of defrosting include electric defrosting, hot gas defrosting, hot brine defrosting and water or air defrosting,

The documents CN 204128254 U and CN 214469483 U each show devices for defrosting heat exchangers.

### SUMMARY

The present disclosure is based on the technical problem of providing a device with a heat exchanger and a method for operating a heat exchanger of a device which enable efficient, demand-oriented and energy-saving defrosting.

The technical problem described above is solved in each case by the independent claims. Further designs of the disclosure result from the dependent claims and the following description.

According to a first aspect, the disclosure relates to a device having a heat exchanger, wherein the heat exchanger has pipes which carry a cooling medium, wherein the heat exchanger has a fin arrangement which is penetrated by the pipes, and wherein the heat exchanger has a heating device integrated in the heat exchanger, with a control device for controlling the heating device. The device is characterized in that the heating device has two or more separately controllable heating sections, wherein each heating section is assigned a defrosting area of the heat exchanger, and wherein the heating device is set up for separate defrosting of individual defrosting areas of the heat exchanger by means of the separately controllable heating sections.

The separately controllable heating sections enable more targeted defrosting of the heat exchanger. In this way, the separately controllable heating sections can be used to apply heat to the areas of the heat exchanger where icing is actually present. Furthermore, heating sections whose associated defrosting areas have already defrosted can be switched off, while other heating sections whose associated defrosting areas have not yet completely defrosted can continue to apply heat to the defrosting area.

The device according to the disclosure therefore has the advantage that defrosting by means of the heating sections can be carried out area by area, i.e. selectively for the defrosting areas. Furthermore, the device according to the disclosure has the advantage that the defrosting of the defrosting areas can be controlled individually for each of the defrosting areas, i.e. a temperature control or heat input can be controlled area by area. In this way, the energy input during defrosting can be reduced since, in comparison to a heating device that cannot be controlled by area, the entire heat exchanger does not have to be heated over the entire period of defrosting.

A defrosting area of the heat exchanger can, for example, be a volume area of the heat exchanger, which comprises parts of one or more fins of the fin arrangement and parts of the piping. Furthermore, a heating section assigned to the defrosting area or the volume area can be arranged within the assigned defrosting area or volume area.

It may be provided that the two or more separately controllable heating sections and the defrosting areas of the heat exchanger assigned to each heating section are arranged in rows and/or columns. For example, the defrosting areas of the heat exchanger can be arranged in rows, wherein a respective row extends essentially over the entire length of the heat exchanger and, for example, two or more rows are arranged one above the other when viewed along a height of the heat exchanger. Alternatively, the defrosting areas of the heat exchanger can be arranged in columns, wherein a respective column extends essentially over the entire height of the heat exchanger and, for example, two or more columns are arranged next to each other along a length of the heat exchanger. Alternatively, the defrosting areas of the heat exchanger can be arranged in rows and columns in a grid-like pattern.

According to one design of the device, it may be provided that heating elements of the heating device are partially or completely arranged within an envelope of the fin arrangement. When referring to an envelope of the fin arrangement, this comprises a volume which is limited by the maximum outer dimensions of the fin arrangement. For example, it may be provided that the heating elements penetrate the fin arrangement. It may be provided that two or more heating elements are arranged parallel to each other, at least in sections, when viewed along a longitudinal extension of the heat exchanger.

It may be provided that the heating elements have electrical heating elements, such as heating rods or the like, which penetrate the fin arrangement. The heating elements can therefore be resistance heating elements, which heat up due to their resistance when electrical power is passed through them, wherein electrical energy is converted into heat.

The heating elements can, for example, be inserted through openings in the fins of the fin arrangement and be attached to or rest against the fins. It may be provided that each of the heating elements penetrates the fin arrangement completely when viewed along its longitudinal extension. Alternatively, the heating elements can be arranged in empty pipes that penetrate the fins. Such empty pipes simplify the installation and maintenance of the heating elements.

According to one design of the device, each heating section can be assigned a separately controllable heating element.

Alternatively, it may be provided that each heating section can be assigned a controllable segment of a heating rod. A respective heating element can, for example, have 2 or more separately controllable segments.

Alternatively, it may be provided that each heating section can be assigned a heating rod group. A heating rod group can have two or more heating elements that can be controlled together.

Alternatively, it may be provided that each heating section is assigned a bow-shaped electrical heating element or a group of bow-shaped electrical heating elements. Such a bow-shaped or fork-shaped electrical heating element has, in particular, two longitudinal sections that extend substantially parallel to one another, the ends of which are arranged adjacent to one another and are connected to a source for the supply of electrical energy, wherein the longitudinal sections are connected to one another in an arcuate manner or merge into one another in an area facing away from the ends.

It may be provided that the heating elements have pipes that penetrate the fin arrangement.

According to one design of the device, it may be provided that each heating section is assigned a controllable pipe, wherein control is carried out by means of switchable valves.

Alternatively, it may be provided that each heating section is assigned a controllable segment of a pipe, wherein control is carried out by means of switchable valves.

Alternatively, it may be provided that each heating section can be assigned a controllable group of pipes, wherein control is carried out by means of switchable valves.

A heatable fluid, such as hot gas, warm brine or the like, can flow through such a pipe of the heating device in order to heat a respective heating section and defrost the associated defrosting area of the heat exchanger. The device can have an additional device for storing and/or heating the heatable fluid.

It may be provided that the pipes of the heating direction which serve as heating elements are provided separately from those pipes of the heat exchanger which carry the cooling medium. Accordingly, fins of the fin arrangement of the heat exchanger are penetrated on the one hand by pipes which carry the cooling medium and on the other hand by pipes of the heating device which are set up to carry a heatable fluid. In particular, it may be provided that a heating circuit of the heating device is a separate fluid circuit from a cooling circuit of the heat exchanger, wherein there is no fluid connection between the heating circuit and the cooling circuit.

According to one design of the device, it may be provided that the pipes of the heating direction which serve as heating elements correspond to those pipes of the heat exchanger that carry the cooling medium, wherein the pipes can be switched between heating mode and cooling mode by means of the control device. It is advantageous here that no separate pipes of the heating device need to be provided in the fin arrangement of the heat exchanger. Accordingly, more surface area is available for heat transfer at the respective fins of the fin arrangement compared to a solution with separate pipes for the heating device. In addition, costs can be saved and the overall design complexity of the heat exchanger can be reduced by eliminating the separate pipes for the heating device.

The heating device can have a hot gas defrosting system and/or a warm brine defrosting system.

The hot gas defrosting and/or warm brine defrosting can be provided separately and Independently of a cooling circuit of the heat exchanger, wherein pipes of the hot gas defrosting and/or warm brine defrosting penetrate the fin arrangement of the heat exchanger.

For example, it may be provided that an expansion valve, a changeover valve, such as a two-way valve, a three-way valve or the like, a compressor, an evaporator and a condenser are provided, which form a refrigeration circuit, wherein the heat exchanger forms the evaporator or the condenser and wherein the heating direction has a hot gas defrosting system or a warm brine defrosting system, which can be switched by means of the changeover valve.

It may be provided that the device has exactly one expansion valve.

It may be provided that the device has exactly one refrigeration circuit.

It may be provided that the heat exchanger has exactly one inflow and exactly one outflow for introducing a refrigerant into the heat exchanger and for discharging the refrigerant from the heat exchanger. The inflow can also be referred to as the inlet. The outflow can also be referred to as the outlet.

In particular, it may be provided that exactly one expansion valve is provided, a changeover valve, such as a two-way valve, a three-way valve, a four-way valve or the like, a compressor, an evaporator and a condenser are provided, which form exactly one refrigeration circuit, wherein the heat exchanger forms the evaporator or the condenser, wherein the heat exchanger has exactly one inflow and exactly one outflow, or exactly one inlet and exactly one outlet, for introducing a refrigerant into the heat exchanger and for discharging the refrigerant from the heat exchanger, wherein the heating direction has a hot gas defrost or a warm brine defrost which can be switched by means of the changeover valve,

It may be provided that exactly two expansion valves are provided, wherein the device has exactly one refrigeration circuit in which the expansion valves are arranged. In particular, one of the two expansion valves serves as an expansion valve for cooling operation of the device, while the other of the two expansion valves serves as an expansion valve for heating operation for defrosting the heat exchanger when the circuit is reversed.

It may be provided that a distributor is arranged between an expansion valve and the heat exchanger, which distributes the cooling fluid to several pipe strings.

It may be provided that adjustment valves, Le. valves for adjusting a flow rate, may be provided between the distributor and the heat exchanger to adjust a flow rate for each of the pipe strings. Each of the adjustment valves may be a controllable valve.

An adjustment valve is not an expansion valve. An adjustment valve regulates the flow rate at an essentially constant fluid pressure, whereas an expansion valve is used to relieve the pressure of the fluid, i.e. to reduce the fluid pressure.

According to one design of the device, it may be provided that the control device is set up for sensor-controlled control of the heating device, wherein at least one monitoring device is provided, such as a sensor, a device for photographic imaging or the like, and wherein the monitoring device is provided for detecting a degree of icing, for determining a defrosting time and for controlling a defrosting process by means of the control device.

It may be provided that two or more monitoring areas are monitored by means of the monitoring device, wherein the monitoring areas are arranged in rows and/or columns in particular. A defrosting area can be assigned to each monitoring area.

Two or more defrosting areas can be assigned to each monitoring area.

Two or more monitoring areas can be assigned to each defrosting area. If a monitoring device detects icing in a monitoring area that is assigned to the defrosting area, the entire defrosting area can be defrosted, for example.

It may be provided that each defrosting area is assigned exactly one monitoring area.

Alternatively or additionally, it may be provided that each heating section is assigned exactly one defrosting area.

Alternatively or additionally, it may be provided that two or more defrosting areas may be assigned to each heating section.

According to one design of the device, one or more of the monitoring devices listed below may be provided: Temperature sensor, pressure sensor, humidity sensor, device for photographic imaging in the visible wavelength range, device for photographic imaging in the non-visible wavelength range, thermal imaging camera, infrared camera.

The device for photographic imaging in the visible wavelength range can be a digital camera. The device for photographic imaging in the visible wavelength range may be associated with a light source to illuminate the heat exchanger to improve imaging.

The device for photographic imaging in the non-visible wavelength range can be an Infrared camera. An infrared light source can be assigned to the device for photographic imaging in the non-visible wavelength range in order to illuminate the heat exchanger to improve the imaging.

The device for photographic imaging in the non-visible wavelength range can be a thermal imaging camera. Although thermal imaging cameras are sometimes not classified as photographic imaging in the literature, a thermal imaging camera in the sense of the present disclosure is a device for photographic imaging in the non-visible wavelength range. The thermal imaging camera generates thermal images that reproduce temperature differences or the heat signature of the detected object, in this case the heat exchanger. To generate such a thermal image, no light source is required to illuminate the object in question, Le. in this case no light source is required to illuminate the heat exchanger.

It may be provided that a first group of one or more monitoring areas is associated with a first arrangement of one or more first monitoring devices for monitoring the first group of one or more monitoring areas and that a second group of one or more monitoring areas is associated with a second arrangement of one or more second monitoring devices to monitor the second group of one or more monitoring areas. Depending on the dimensions of the heat exchanger, several monitoring devices can therefore be provided for monitoring one or more monitoring areas,

Depending on the length of the heat exchanger, for example, it may be provided that several cameras may be provided in order to be able to monitor the heat exchanger completely. For example, several cameras can be lined up at a distance from each other along the length of the heat exchanger, wherein each camera monitors a partial length of the heat exchanger. Each partial length can have one or more monitoring areas.

A temperature sensor can be assigned to each monitoring area.

A pressure sensor can be assigned to each monitoring area.

A humidity sensor can be assigned to each monitoring area.

According to one design of the device, it may be provided that the control device is set up for time-based and/or sensor-controlled control of the heating device and/or the control device is set up for AI-based control of the heating device and/or the control device is set up to control the heating device using thermal images taken by means of a thermal imaging camera of the device. The defrosting of the individual defrosting areas can therefore be controlled by means of a timer or sensor-controlled by means of one or more temperature sensors, wherein, for example, a temperature sensor is assigned to each defrosting area. Alternatively or additionally, thermal Images of individual monitoring areas can be evaluated in order to detect the progress of a defrosting process and to specify an end of the defrosting process for each of the defrosting areas.

In the aforementioned context, the term “AI” includes methods based on artificial Intelligence and refers collectively to methods from the fields of “machine learning” and “deep learning”. For example, an AI-based image evaluation can be carried out to detect the icing condition of a respective monitoring area, wherein, for example, conventional digital images, infrared images or thermal images can be evaluated. Such images can be used to determine a defrosting time on the one hand and to control the defrosting process on the other.

According to a second aspect, the disclosure relates to a method comprising the steps of: operating a heat exchanger of a device; defrosting the heat exchanger by means of a heating device of the heat exchanger. The method is characterized in that, during defrosting of the heat exchanger, two or more separately controllable heating sections of the heating device are controlled by means of a control device and defrosting areas of the heat exchanger assigned to the heating sections are defrosted by means of the separately controllable heating sections.

It may be provided that initially all defrosting areas are defrosted simultaneously and then individual or several heating sections are switched off. In this way, heat can initially be quickly introduced into the heat exchanger in order to subsequently control the defrosting in a targeted manner for specific areas according to the defrosting areas and the correspondingly assigned heating sections. In this way, rapid and efficient defrosting can be achieved.

Alternatively or additionally, it may be provided that one or more defrosting areas of the heat exchanger are defrosted, while one or more other defrosting areas of the heat exchanger are not defrosted. During defrosting, individual defrosting areas can therefore not be defrosted by means of the assigned heating elements, while other defrosting areas are defrosted by means of the assigned heating elements.

Alternatively or additionally, it may be provided that a defrosting area or several defrosting areas of the heat exchanger are defrosted with a first heat output, while a further defrosting area or several further defrosting areas of the heat exchanger are defrosted with a second heat output that is different from the first heat output. The heat input into the relevant defrosting areas can therefore be controlled in a targeted and demand-oriented manner.

A respective heating output can be set, for example, by pulse width modulation.

For example, it may be provided that the heat output of individual heating elements is actively regulated. For an electric heating element, for example, a power supply can be regulated, while for a pipe, the degree of opening of a valve can be regulated.

According to one design of the method, it may be provided that the defrosting areas of the heat exchanger are defrosted row by row and/or column by column.

It may be provided that a degree of icing of the heat exchanger is monitored during operation of the heat exchanger, wherein two or more monitoring areas of the heat exchanger are monitored by means of at least one monitoring device, wherein a degree of icing is determined for each monitoring area of the heat exchanger, wherein the monitoring areas are arranged in particular in rows and/or columns.

According to one design of the method, it may be provided that the device is designed according to the disclosure and/or the control of the heating device is carried out in a time-based and/or sensor-controlled manner and/or the control of the heating device is carried out in an AI-based manner and/or the control of the heating device is carried out using thermal images from a thermal imaging camera.

### BRIEF DESCRIPTION OF THE DRAWINGS

The disclosure is described in more detail below with reference to drawings illustrating exemplary embodiments, which show schematically in each case:

FIG. 1 shows a perspective view of a device according to the disclosure;

FIG. 2 shows a perspective view of the device in FIG. 1 without housing;

FIG. 3A shows the heat exchanger of the device in FIG. 1 with continuous heating rods;

FIG. 3B shows heating sections and defrosting areas of the heat exchanger from FIG. 3A;

FIG. 3C shows the heat exchanger from FIG. 3A without heating sections and defrosting areas;

FIG. 4A shows a heat exchanger for a device according to FIG. 1 with non-continuous heating rods;

FIG. 4B shows heating sections and defrosting areas of the heat exchanger from FIG. 4A;

FIG. 4C shows the heat exchanger from FIG. 4A without heating sections and defrosting areas;

FIG. 5 shows another device according to the disclosure;

FIG. 6 shows the heat exchanger of the device in FIG. 5;

FIG. 7 shows another device according to the disclosure;

FIG. 8 shows another device according to the disclosure;

FIG. 9 shows another device according to the disclosure; and

FIG. 10 shows another device according to the disclosure.

### DETAILED DESCRIPTION OF THE DRAWINGS

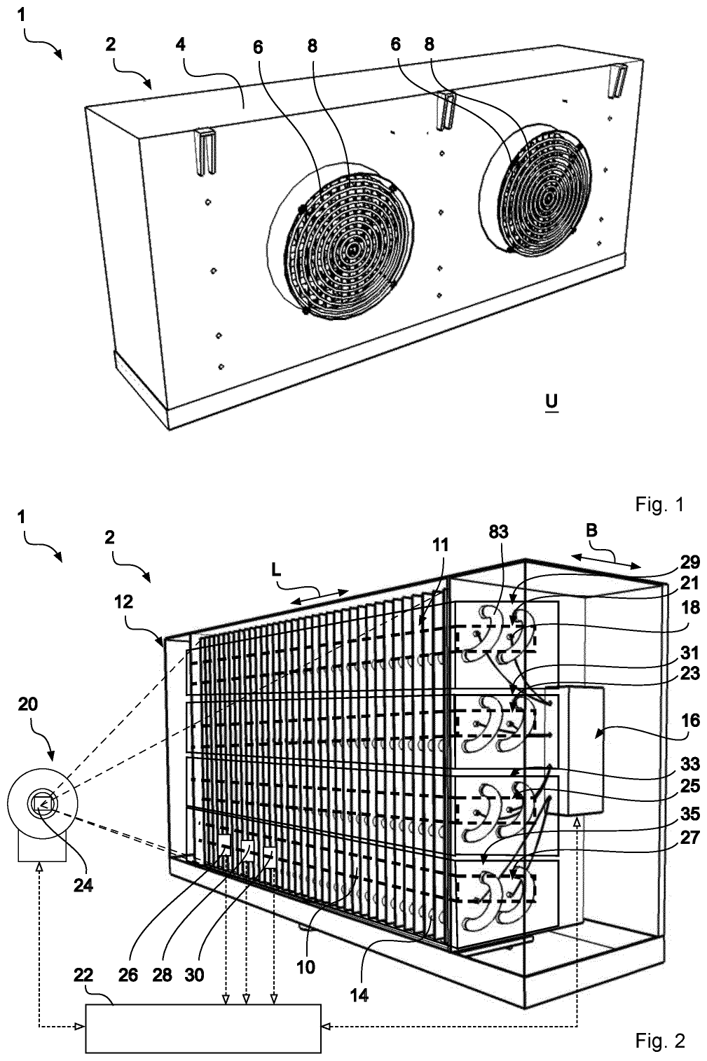

FIG. 1 shows a device 2 according to the disclosure. The device 2 is a cooling system 2. The cooling system 2 can be used, for example, to cool a walk-in cooling volume.

The cooling system 2 has a housing 4 that supports protective grilles 6 of fans 8 of the cooling system 2. The fans 8 are used to convey air from an environment U along fins 10 of a heat exchanger 12 of the cooling system 2. The heat exchanger 12 is described below with reference to FIG. 2.

The heat exchanger 12 is located inside the cooling system 2, so that the housing 4 is hidden to illustrate the heat exchanger 12 in FIG. 2. The heat exchanger 12 has a large number of flat or plate-shaped fins 10 which are lined up essentially parallel to each other along a longitudinal extension L of the heat exchanger 12 and which form a fin arrangement 11.

The fins 10 are traversed by pipes 14 of the heat exchanger 12, which carry a cooling medium. The fins 10 can also be referred to as cooling fins 10. The cooling fins 10 are connected to the pipes 14 of the heat exchanger 12.

The device 2 has a heating device 16 integrated into the heat exchanger 12 with heating rods 18 for defrosting the heat exchanger 12. The heating rods 18 also pass through the cooling fins 10 along the longitudinal direction L and are connected to the cooling fins 10.

The device 2 has a device 20 for photographic imaging. The device 20 is used to generate photographic images of the heat exchanger 12 and to transmit them to a control unit 22 of the device 2. The control unit 22 may have a computer for evaluating photographic images, may be connected to a computer for evaluating photographic images and/or may be connected to a server for evaluating photographic images.

Device 20 is a thermal imaging camera.

The control unit 22 is also used to control the heating device 16.

The heating device 16 has four separately controllable heating sections 21, 23, 25, 27. Two heating elements 18 are assigned to each of the heating sections 21, 23, 25, 27. The heating elements 18 of a respective heating section 21, 23, 25, 27 can be controlled separately, so that the heating sections 21, 23, 25, 27 can be heated independently of one another.

A defrosting area 29, 31, 33, 35 of the heat exchanger 12 is assigned to each heating section 21, 23, 25, 27, wherein each defrosting area 29, 31, 33, 35 is a volume region 29, 31, 33, 35 surrounding the respectively assigned heating section 21, 23, 25, 27.

The heating device 16 is therefore set up for separate defrosting of the individual defrosting areas 29, 31, 33, 35 of the heat exchanger 12 by means of the separately controllable heating sections 21, 23, 25, 27.

The defrosting areas 29, 31, 33, 35 also correspond to monitoring areas 29, 31, 33, 35 of the thermal imaging camera 20, so that a degree of icing can be detected for each of the monitoring areas 29, 31, 33, 35 by means of the thermal imaging camera 20.

It may be provided that two or more thermal imaging cameras 20 are provided for monitoring the monitoring areas 29, 31, 33, 35. In addition, further monitoring devices such as temperature sensors 26, pressure sensors 28 and humidity sensors 30 may be provided for each of the monitoring areas 29, 31, 33, 35 in order to detect an icing condition of the relevant monitoring area 29, 31, 33, 35 and/or to control a defrosting of the associated defrosting area 29, 31, 33, 35 by means of the heating sections 21, 23, 25, 27.

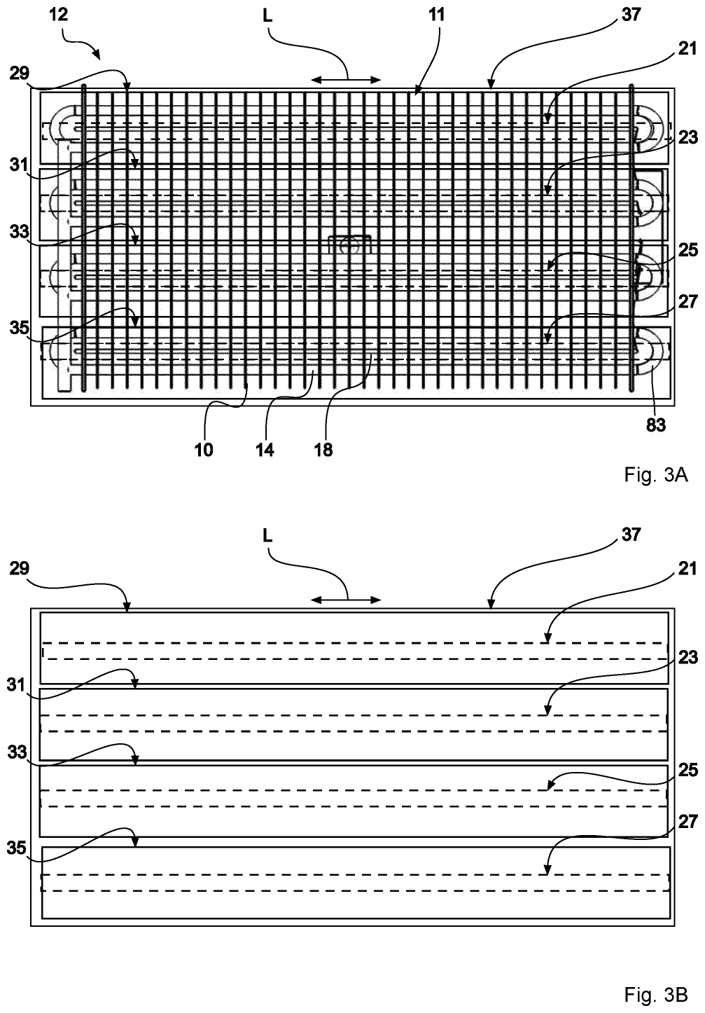

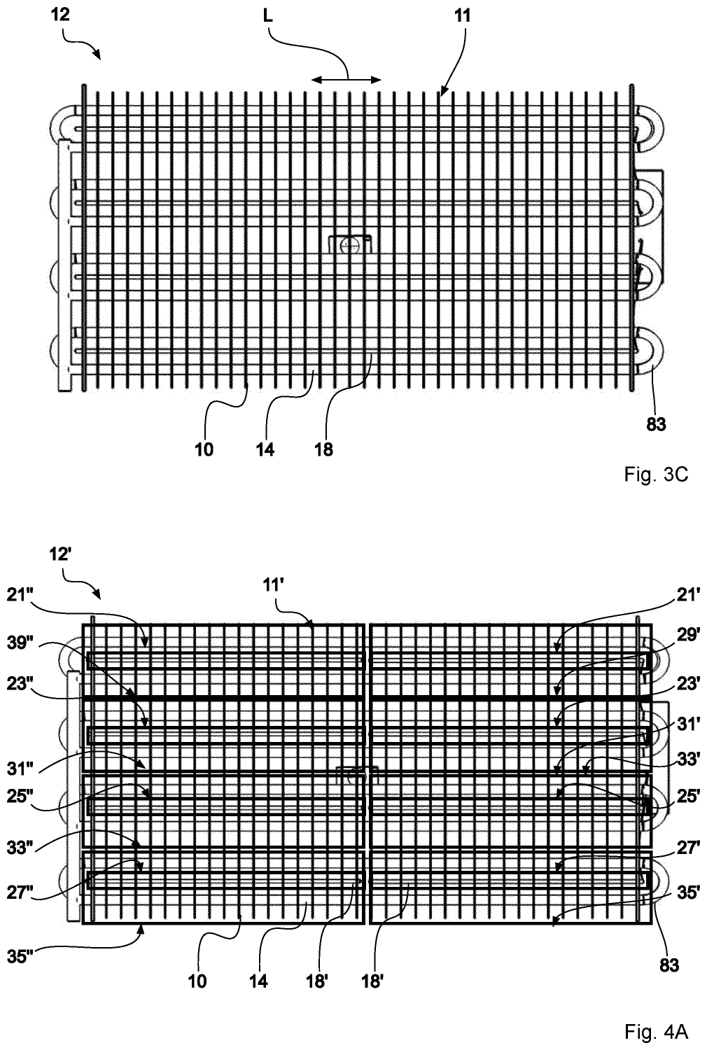

FIG. 3A shows the cooling fins 10 of the heat exchanger 12 with the heating rods 18 and the pipes 14. According to FIG. 3A, the heating rods 18 completely penetrate the arrangement of the fins 10 along the longitudinal direction L over the entire length. The heating sections 21, 23, 25, 27 and the defrosting areas 29, 31, 33, 35 are also shown.

The heating sections 21, 23, 25, 27 and the defrosting areas 29, 31, 33, 35 are arranged in rows so that defrosting can take place row by row.

The heating device 16 and the heating elements 18 are essentially arranged completely within an envelope 37 of the heat exchanger 12. It is understood that the envelope 37 shown here in only two dimensions delimits a volume which completely encloses the heat exchanger 12 in three-dimensional space.

In the present case, the heating elements 18 are electric heating elements in the form of heating rods 18.

For a better overview, the heating sections 21, 23, 25, 27 and the defrosting areas 29, 31, 33, 35 are shown in FIG. 3B without the heat exchanger 12.

For a better overview, the heat exchanger 12 is shown in FIG. 3C without the heating sections 21, 23, 25, 27 and the defrosting areas 29, 31, 33, 35.

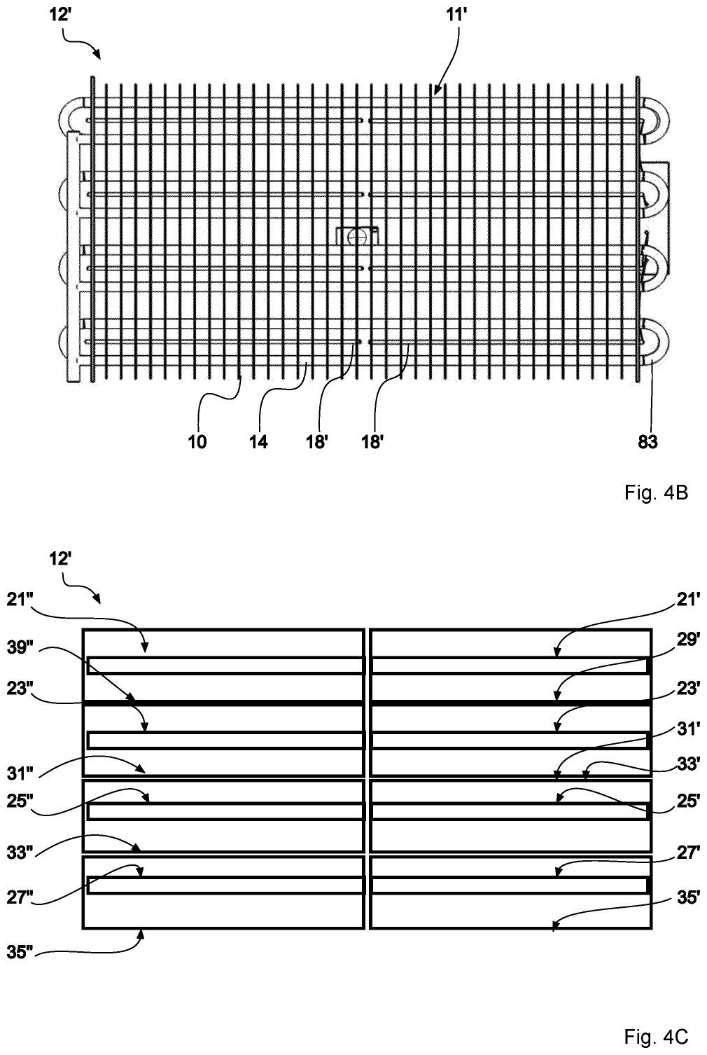

FIG. 4A shows an alternative design of a heat exchanger 12′, which can also be used in a device 2 according to the disclosure. The heat exchanger 12′ according to FIG. 4 differs from the heat exchanger 12 according to FIG. 3 in that heating rods 18′ are provided which only penetrate the arrangement of fins 10 over a partial length when viewed along the longitudinal direction L.

The heat exchanger 12′ has eight heating sections 21′, 23′, 25′, 27′, 21″, 23″, 25″, 27″ and eight associated defrosting areas 29′, 31′, 33′, 35, 29″, 31″, 33″, 35″. The defrosting areas 29′, 31′, 33′, 35′, 29″, 31″, 33″, 35″ can each be defrosted or heated separately, i.e. independently of one another, by means of the heating sections 21′, 23, 25, 27, 21″, 23″, 25″, 27″.

For a better overview, the heat exchanger 12′ is shown in FIG. 4B without the defrosting areas and heating sections.

For a better overview, the heating sections 21′, 23′, 25, 27, 21″, 23″, 25″, 27″ and the defrosting areas 29′, 31′, 33′, 35′, 29″, 31″, 33″, 35″ are shown in FIG. 4C without the heat exchanger 12′.

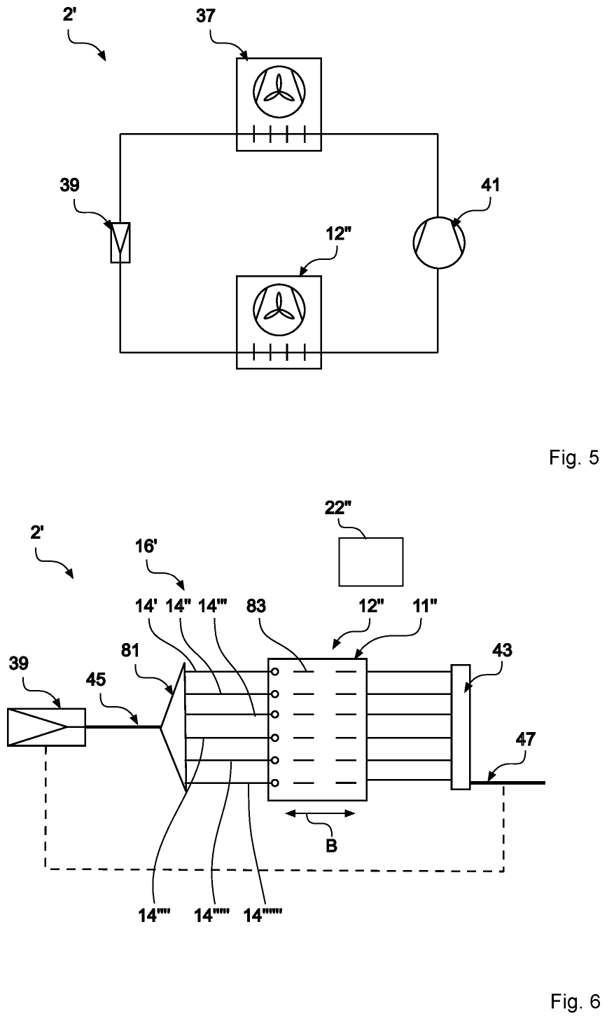

FIG. 5 shows a device 2′, which is a cooling system. The device 2′ has an evaporator 12″, a condenser 37, an expansion valve 39 and a compressor 41.

The heat exchanger 12″ or evaporator has six pipe strings 14′, 14″, 14′″, 14″″, 14″″, 14′″″, 14″″″ or pipe groups 14′, 14″, 14′″, 14″″, 14″″, 14′″″, 14″″″, each of which has five pipes (FIG. 6). The pipes of the pipe strings 14′, 14″, 14′″, 14″″, 14″″, 14′″″, 14″″″ penetrate a fin arrangement 11″ of the heat exchanger 12″.

The pipes are segments of the pipe strings 14′, 14″, 14′″, 14″″, 14″″, 14′″″, 14″″″ wherein the pipes extending along the longitudinal extension of the heat exchanger 12″, i.e. the pipes extending perpendicular to the plane of the drawing, are connected to one another via bends 83. The pipe strings 14′, 14″, 14′″, 14″″, 14″″, 14′″″, 14″″″ therefore penetrate the fin arrangement 11″ in a meandering manner along a width B of the heat exchanger 12″.

The pipes of the pipe strings 14′, 14″, 14′″, 14″″, 14″″, 14′″″, 14″″″ are pipes of the heat exchanger 12″, which carry the cooling medium. The pipes of the pipe strings 14′, 14″, 14′″, 14″″, 14″″, 14′″″, 14″″″ are also pipes of a heating direction 16″ and serve as heating elements. The pipes of the pipe strings 14′, 14″, 14′″, 14″″, 14″″, 14′″″, 14″″″ can be switched between heating and cooling mode by means of the control device 22″.

The device 2′ has a distributor 81, a collector 43, an inlet 45 for introducing a cooling medium and an outlet 47 for discharging a cooling medium from the heat exchanger 12″.

The pipe strings 14′, 14″, 14′″, 14″″, 14″″, 14″″, 14′″″ can be controlled separately and thus form heating sections of a heating device 16′, which can defrost the surrounding defrosting areas of the heat exchanger 12″ separately, for example by reversing the circuit. The pipe strings 14′, 14″, 14′″, 14″″, 14″″, 14′″″, 14″″″ can be switched by means of the control device 22″ by means of valves (not shown).

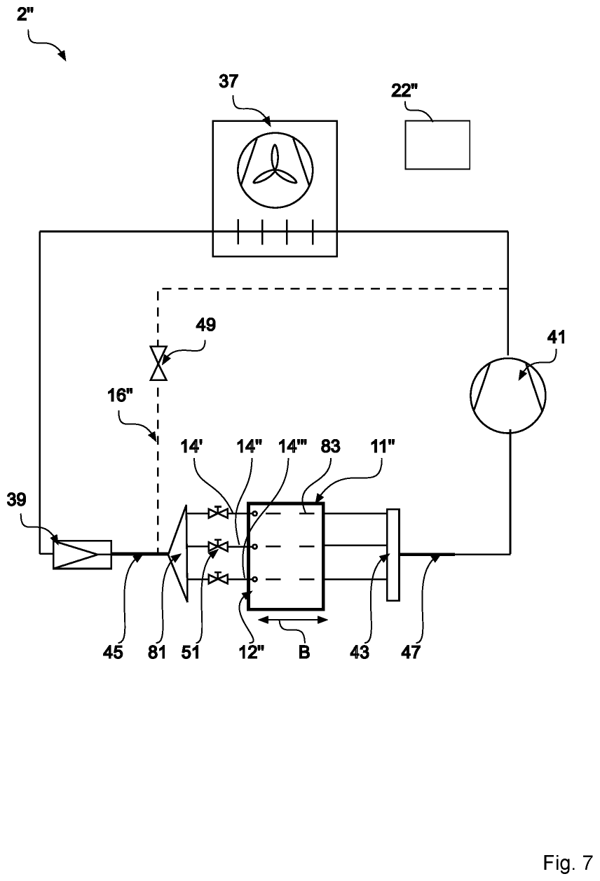

FIG. 7 shows a further device 2″, wherein only the differences to the device 2′ described above are discussed and the same reference signs are assigned to the same features.

The device 2″ has a heating device 16″ in the form of a hot gas defrosting system. A two-way valve 49 is provided for this purpose, which is set up to switch between cooling mode and heating mode or defrosting mode.

The valves 51 of the pipe strings 14′, 14″, 14′″ can each be controlled separately, so that hot gas can flow through the pipe strings 14′, 14″, 14′″ separately and independently of one another in order to carry out selective defrosting of the heat exchanger 12″. The valves 51 are adjustment valves for adjusting a flow rate in order to set a flow rate for each of the pipe strings 14′, 14″, 14′″.

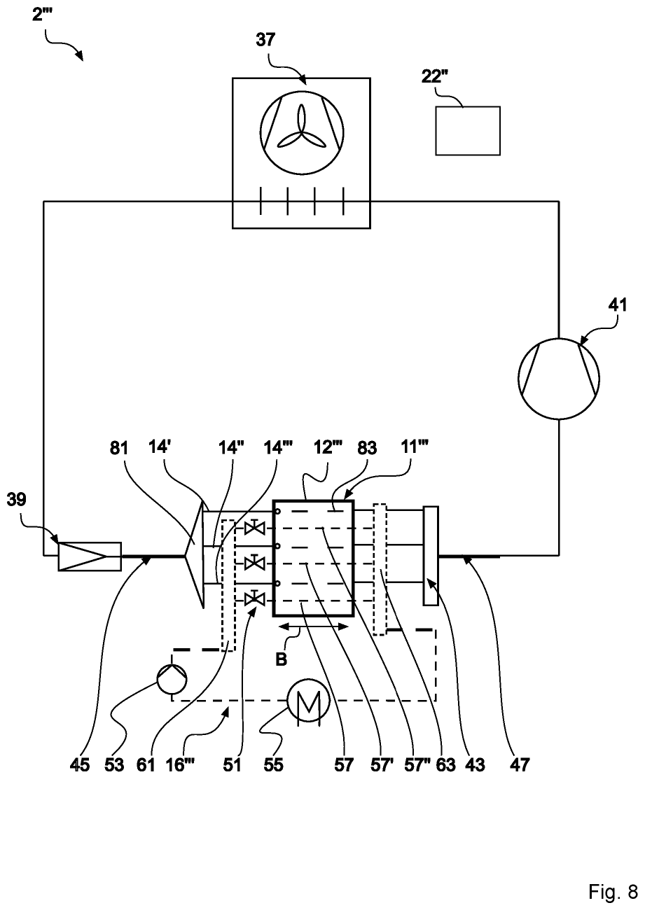

FIG. 8 shows a further device 2′″, wherein only the differences to the devices 2′, 2″ described above are discussed and the same reference signs are assigned to the same features.

The device 2′″ has a heating device 16′″ in the form of a hot gas or warm brine defrosting system, whose pipes 57, 57′, 57″ or heating sections 57, 57′, 57″ are provided separately from the pipes 14′, 14″, 14′″, which carry the cooling medium. The pipes 57, 57′, 57″ pass through the heat exchanger 12′″. For the device 2′″, the cooling circuit and the heating circuit are therefore completely separate from each other.

The heating device 16′″ has a pump 53, a heat source 55, e.g. in the form of a resistance heater or the like, a distribution pipe 61 as inlet and a collecting pipe 63 as outlet. Alternatively or additionally, the waste heat from the compressor 41 can serve as a heat source.

The heat exchanger 12′″ can therefore be selectively supplied with hot gas by means of the pipes 57, 57′, 57″ in order to defrost the heat exchanger 12′″ selectively, i.e. region by region. Alternatively, the heating device 16′″ can be operated with hot brine.

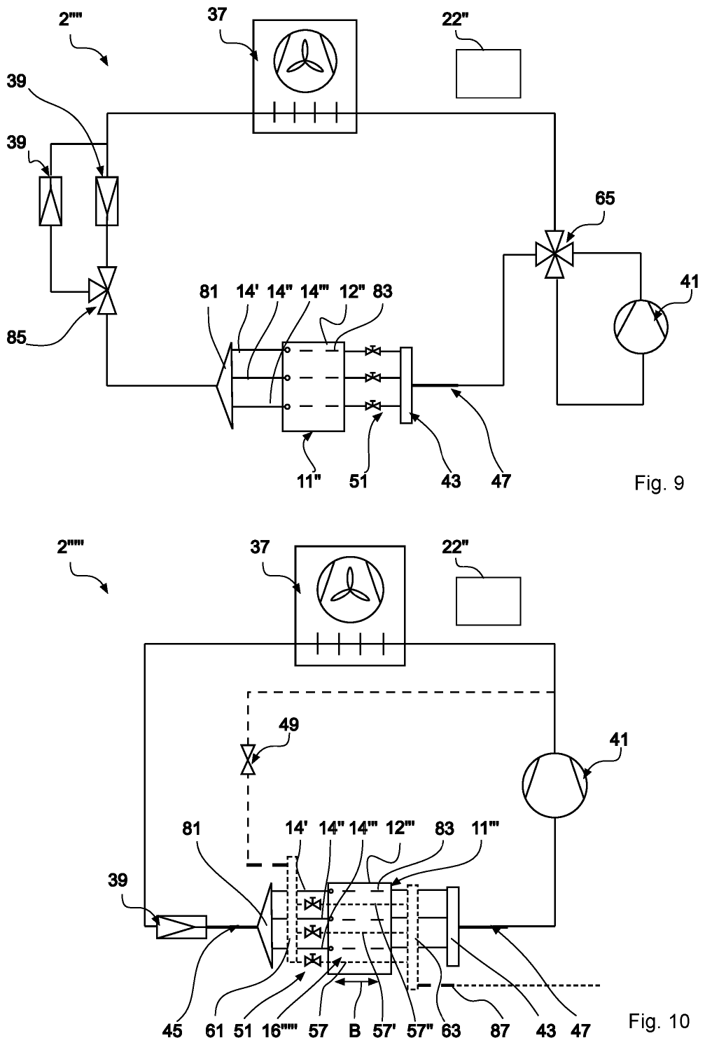

FIG. 9 shows a further device 2″″, wherein only the differences to the devices 2′, 2″, 2′″ described above are discussed and the same reference signs are assigned to the same features,

For the device 2″″ as shown in FIG. 9, the pipes 14′, 14″, 14′″ are again used for both cooling and heating operation. A circuit reversal is used to switch between cooling mode and heating mode, wherein a three-way valve 85 and a four-way valve 65 are used to switch the circuit direction. The valves 51 can be used to selectively defrost the heat exchanger 12″ in heating mode, in which the pipes 14′, 14″, 14′″ are flowed through or not flowed through depending on the valve position of the valves 51.

FIG. 10 shows a further device 2′″″, wherein only the differences to the device 2′″ described above are discussed and the same reference signs are assigned to the same features.

The device 2′″″ has a heating device 16′″″ in the form of a hot gas or warm brine defrosting system, the pipes 57, 57′, 57″ or heating sections 57, 57′, 57″ of which are provided separately from the pipes 14′, 14″, 14′″, which carry the cooling medium. The pipes 57, 57′, 57″ pass through the heat exchanger 12′″. For the device 2′″″, the cooling circuit and the heating circuit are therefore completely separate from each other.

The collecting pipe 63 of the heating device 16′″″ is connected here to an outlet 87, which opens into a collector or a separator, for example.

Defrosting can proceed as follows for each of the devices described above:

The monitoring equipment is used to monitor the degree of icing of a respective heat exchanger, in particular to monitor areas in accordance with predefined monitoring ranges.

If defrosting is required, all heating sections with their assigned heating elements are preferably activated first.

Defrosting can be monitored by means of the monitoring devices on a section-by-section basis. If a defrosting area in question has defrosted, the associated heating sections can be switched off until all heating sections have been switched off and the heat exchanger has completely defrosted.

In particular, thermal images of the monitored areas can be used to record the defrost status for the defrosting areas. The evaluation of the thermal images or thermal image recordings can be carried out in an AI-based manner.

1. A device comprising:
a heat exchanger,
wherein the heat exchanger has pipes which carry a cooling medium,
wherein the heat exchanger has a fin arrangement which is penetrated by the pipes,
and wherein the heat exchanger has a heating device integrated in the heat exchanger,
with a control device for controlling the heating device,
wherein
the heating device has two or more separately controllable heating sections,
wherein each heating section is assigned a defrosting area of the heat exchanger,
and wherein the heating device is set up for separate defrosting of individual defrosting areas of the heat exchanger by the separately controllable heating sections.

2. The device according to claim 1, wherein
the two or more separately controllable heating sections and the defrosting areas of the heat exchanger assigned to each heating section are arranged in rows and/or columns.

3. The device according to claim 1, wherein
heating elements of the heating device are arranged partially or completely within an envelope of the fin arrangement.

4. The device according to claim 3, wherein
the heating elements comprise electric heating elements, such as heating rods or the like, which penetrate the fin arrangement.

5. The device according to claim 3, wherein
each heating section is assigned a separately controllable heating rod or
in that each heating section is assigned a controllable segment of a heating rod or
in that each heating section is assigned a heating rod group or
in that each heating section is assigned a bow-shaped electrical heating element.

6. The device according to claim 3, wherein
the heating elements have pipes which penetrate the fin arrangement.

7. The device according to claim 6, wherein
each heating section is assigned a controllable pipe or each heating section is assigned a controllable segment of a pipe or each heating section is assigned a controllable group of pipes,
wherein control is carried out by switchable valves.

8. The device according to claim 6, wherein
the pipes of the heating direction which serve as heating elements are provided separately from those pipes of the heat exchanger which carry the cooling medium.

9. The device according to claim 6, wherein
the pipes of the heating direction which serve as heating elements correspond to those pipes of the heat exchanger which carry the cooling medium,
wherein the pipes are configured to be switched between a heating mode and a cooling mode by the control device.

10. The device according to claim 8, wherein
an expansion valve,
a changeover valve, such as a two-way valve, a three-way valve, a four-way valve or the like,
a compressor,
an evaporator and
a condenser are provided, which form a refrigeration circuit,
wherein the heat exchanger forms the evaporator or the condenser,
wherein the heating direction has a hot gas defrosting system or a warm brine defrosting system, which can be switched by the changeover valve.

11. The device according to claim 1,
wherein
the control device is set up for sensor-controlled control of the heating device,
wherein at least one monitoring device is provided, such as a sensor, a device for photographic imaging or the like, and
wherein the monitoring device is provided for detecting a degree of icing, for determining a defrosting time and for controlling a defrosting process by the control device.

12. The device according to claim 11, wherein
two or more monitoring areas are monitored by the monitoring device,
wherein the monitoring areas are arranged in rows and/or columns.

13. The device according to claim 11, wherein
one or more of the monitoring devices listed below are provided:
temperature sensor,
pressure sensor,
humidity sensor,
device for photographic imaging in the visible wavelength range,
device for photographic imaging in the non-visible wavelength range,
thermal imaging camera,
infrared camera.

14. The device according to claim 11,
wherein a first group of one or more monitoring areas is associated with a first arrangement of one or more first monitoring devices for monitoring the first group of one or more monitoring areas, and
wherein a second group of one or more monitoring areas is associated with a second arrangement of one or more second monitoring devices for monitoring the second group of one or more monitoring areas.

15. The device according to claim 1, wherein
the control device is set up for time-based and/or sensor-controlled control of the heating device and/or
the control device is set up for AI-based control of the heating device and/or
the control device is set up to control the heating device using thermal images taken by a thermal imaging camera of the device.

16. A method including the following steps of:
operating a heat exchanger of a device;
defrosting the heat exchanger by a heating device of the heat exchanger; whereby
during defrosting of the heat exchanger, two or more separately controllable heating sections of the heating device are controlled by a control device, and
defrosting areas of the heat exchanger assigned to the heating sections are defrosted by the separately controllable heating sections.

17. The method according to claim 16, wherein
all defrosting areas are defrosted simultaneously and then individual or several heating sections are switched off, and/or
defrosting of one defrosting area or several defrosting areas of the heat exchanger takes place, while no defrosting takes place for one or more further defrosting areas of the heat exchanger, and/or
defrosting of one defrosting area or several defrosting areas of the heat exchanger takes place with a first heating power, while defrosting of a further defrosting area or several further defrosting areas of the heat exchanger takes place with a second heating power which is different from the first heating power.

18. The method according to claim 16, wherein
the defrosting areas of the heat exchanger are defrosted row by row and/or column by column.

19. The method according to claim 16, wherein
a degree of icing of the heat exchanger is monitored during operation of the heat exchanger,
wherein two or more monitoring areas (29, 31, 33, 35) of the heat exchanger are monitored by at least one monitoring device,
wherein a degree of icing is determined for each monitoring area of the heat exchanger, wherein the monitoring areas are arranged particular in rows and/or columns.

20. The method according to claim 16, wherein
the device comprises a heat exchanger having pipes which carry a cooling medium, wherein the heat exchanger has a fin arrangement which is penetrated by the pipes, and wherein the heat exchanger has a heating device integrated in the heat exchanger, with a control device for controlling the heating device, wherein the heating device has two or more separately controllable heating sections, wherein each heating section is assigned a defrosting area of the heat exchanger, and wherein the heating device is set up for separate defrosting of individual defrosting areas of the heat exchanger by means of the separately controllable heating sections, and/or
the control of the heating device is carried out in a time-based and/or sensor-controlled manner and/or
the control of the heating device is carried out in an AI-based manner and/or
the control of the heating device is carried out using thermal images from a thermal imaging camera.
